(19) United States
(12) Patent Application Publication
(10) Pub. No.: US 2025/0144984 A1
(43) Pub. Date: May 8, 2025

(54) HORIZONTAL AND VERTICAL VEHICLE PANEL ARRANGEMENTS

(71) Applicant: Magna Exteriors Inc., Aurora (CA)

(72) Inventors: Keijo J. HUOTARI, Fenton, MI (US); Scott L. WOODS, Bruce Township, MI (US); John S. MUGLIA, Shelby Township, MI (US); Riad CHAAYA, Clarkston, MI (US); Heiner SALZMANN, Metamora, MI (US); Hideki YAMAMOTO, Plymouth, MI (US); Zdenek SEVERA, Troy, MI (US)

(73) Assignee: Magna Exteriors Inc., Aurora (CA)

(21) Appl. No.: 18/937,911

(22) Filed: Nov. 5, 2024

Related U.S. Application Data
(60) Provisional application No. 63/596,474, filed on Nov. 6, 2023.

(51) Int. Cl. B60J 5/04; B32B 3/18; B32B 3/30; B32B 5/02; B32B 15/04

(52) U.S. Cl. CPC B60J 5/0455; B32B 3/18; B32B 3/30; B32B 5/02; B32B 15/04; B60J 5/0413; B60J 5/0415; B32B 2260/021; B32B 2260/046; B32B 2605/00

(57) ABSTRACT

A vehicle panel arrangement having an inner panel having strategically positioned load point areas. Each of these load point areas includes a local reinforcement which is connected securely to the outer surface of the inner panel. The arrangement further includes bulkheads extending from the outside surface of the inner panel and a continuous reinforcement in contact with at least two locations on a vehicle body structure. The combination of the local reinforcements, bulkheads and continuous reinforcement ensures that when external forces are applied to the vehicle panel arrangement, the forces are efficiently distributed across the vehicle panel arrangement and to the vehicle body structure through the continuous reinforcement.

### FIELD OF THE INVENTION

The present invention relates to structural arrangements for forming vehicle panels. More particularly the present invention pertains to vehicle panel arrangements designed to enhance structural integrity and load distribution in the vehicle panels, such as roof panels, frunks, trunks, hoods, doors and other similar closure components.

### BACKGROUND OF THE INVENTION

Vehicle closure panels, including those for removable roofs, trunks, hoods, frunks and doors, all of which are integral to the aesthetic and functional aspects of an automobile. These panels are subject to various loads, such as impact forces, and it is imperative to ensure that these forces are properly distributed across the panel structure to prevent damage, deformation or malfunction. Conventional vehicle panel arrangements often suffer from weakness in load bearing capacity and do not effectively distribute forces, thereby compromising vehicle safety durability and overall performance. The need for enhanced structural reinforcement and low distribution and vehicle panels is evident and the present invention addresses these challenges.

### SUMMARY OF THE INVENTION

A vehicle panel arrangement with an inner panel having strategically positioned load point areas. Each of these load point areas includes a local reinforcement connected securely to an outer surface of the inner panel. The vehicle panel arrangement further includes bulkheads extending from the outside surface of the inner panel and a continuous reinforcement in contact with at least two locations on a vehicle body structure. The combination of the local reinforcements, bulkheads and continuous reinforcement ensures that external forces applied to the vehicle panel arrangement are efficiently distributed across the vehicle panel arrangement and the vehicle body structure through the continuous reinforcement. The vehicle panel arrangement described herein offers improved structural reinforcement and efficient distribution of load. This arrangement comprises various components that, when combined, ensure the vehicle closure panel's strength and resilience.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an exploded top perspective view of a vehicle panel arrangement that is a vehicle roof panel having reinforcing bulkheads, ribs and local reinforcements according to an application of a first embodiment of the invention.

FIG. 2 is a cross-sectional side elevational view of the vehicle roof of the first embodiment of the invention.

FIG. 3 is a front perspective view of a vehicle having a vehicle panel arrangement that is a frunk closure of the vehicle having reinforcing bulkheads according to another application of the first embodiment of the invention.

FIG. 4 is a side elevational view of a vehicle panel that is a side door of a vehicle with reinforcing bulkheads according to another application of the first embodiment of the invention.

FIG. 5 is an enlarged cross-sectional side view of a portion of the side door of FIG. 4.

FIG. 6 is a side perspective elevational view of a vehicle having a panel that that is a sliding side door of a vehicle with reinforcing bulkheads according to another application of the first embodiment of the invention.

FIG. 7 is a top perspective view of a vehicle panel arrangement that is a trunk closure of the vehicle having reinforcing bulkheads according to another application of the first embodiment of the invention.

FIG. 8 is a partial cross-sectional side elevational view of the vehicle panel arrangement that is a portion of the vehicle roof shown in FIG. 1 having a local reinforcement according to a second embodiment of the presentation.

FIG. 9 is a partial bottom plan view of the vehicle panel arrangement that is a portion of the vehicle roof shown in FIG. 1 having a local reinforcement according to the second embodiment of the presentation.

FIG. 10 is a front perspective view of a vehicle having a vehicle panel arrangement that is a frunk closure of the vehicle having a local reinforcement according to another application of the second embodiment of the invention.

FIG. 11 is a side perspective elevational view of a vehicle panel that that is a side door of a vehicle having a local reinforcement according to another application of the second embodiment of the invention.

FIG. 12 is a side perspective elevational view of a vehicle having a panel that that is a sliding side door of a vehicle having a local reinforcement according to another application of the second embodiment of the invention.

FIG. 13 is a top perspective view of a vehicle panel arrangement that is a trunk closure of the vehicle having a local reinforcement according to another application of the second embodiment of the invention.

FIG. 14A is a top perspective view of a vehicle panel arrangement that is a vehicle roof, according to an application of a third embodiment of the invention.

FIG. 14B is a bottom plan view of a vehicle panel arrangement that is a vehicle roof, according to the third embodiment of the invention.

FIG. 14C is a top plan view of the vehicle panel arrangement with the exterior panel removed.

FIG. 15 is a partial cross-sectional side elevational view of the continuous reinforcement shown in FIG. 14A according to the third embodiment of the invention.

FIG. 16A is another partial cross-sectional side elevational view of the continuous reinforcement shown in FIG. 14 according to the third embodiment of the invention.

FIG. 16B is a partial enlarged bottom perspective view of a vehicle panel arrangement that is a portion of a vehicle roof having a continuous reinforcement according to an application of a third embodiment of the invention.

FIG. 17 is a side perspective elevational view of a vehicle panel that that is a side door of a vehicle with a continuous reinforcement according to another application of the third embodiment of the invention.

FIG. 18 is a side perspective elevational view of a vehicle having a panel that that is a sliding side door of a vehicle with a continuous reinforcement according to another application of the third embodiment of the invention.

FIG. 19 is a partial enlarged bottom perspective view of a vehicle panel arrangement that is a vehicle roof having groups of ribs according to an application of a fourth embodiment of the invention.

FIG. 20 is a front perspective view of a vehicle having a vehicle panel arrangement that is a frunk closure of the vehicle having groups of ribs according to another application of the fourth embodiment of the invention.

FIG. 21 is a side perspective elevational view of a vehicle panel that is a side door of a vehicle having groups of ribs according to another application of the fourth embodiment of the invention.

FIG. 22 is a side perspective elevational view of a vehicle having a panel that that is a sliding side door of a vehicle having a local reinforcement according to another application of the second embodiment of the invention.

FIG. 23 is a top perspective view of a vehicle panel arrangement that is a trunk closure of the vehicle having groups of ribs according to another application of the fourth embodiment of the invention.

### DETAILED DESCRIPTION OF THE PREFERRED EMBODIMENTS

The following description of the preferred embodiments is merely exemplary in nature and is in no way intended to limit the invention, its application, or uses.

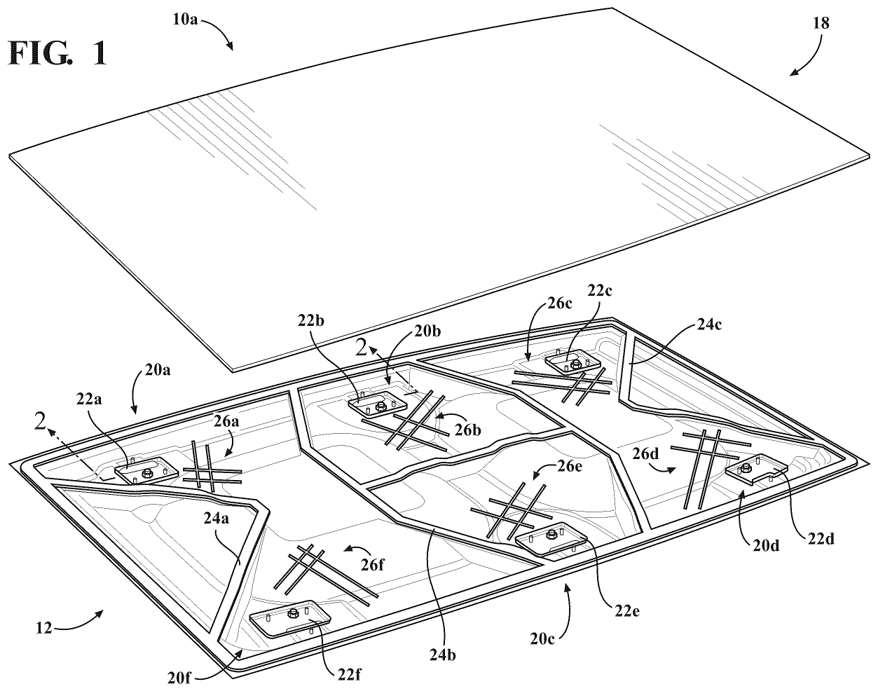

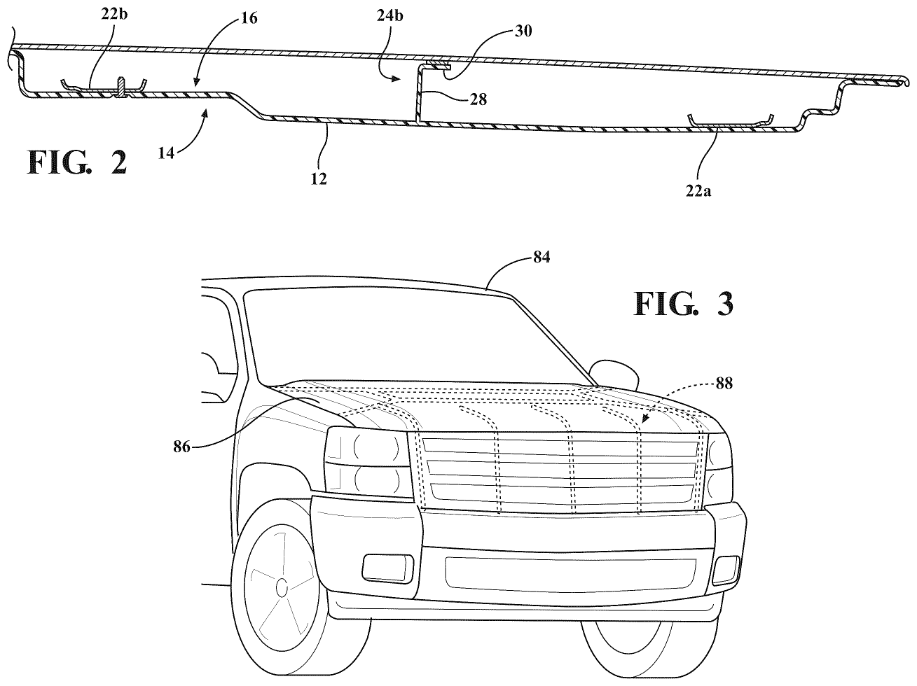

Referring now to FIGS. 1 and 2 a vehicle panel arrangement 10a, specifically a portion of a roof of a vehicle, which is a removable panel that forms all of or a portion of the roof is shown. The vehicle panel arrangement 10a includes an inner panel 12 featuring inner surface 14 forming the inside surface of the vehicle panel, and an outer surface 16 which is covered by an exterior panel 18. The outer surface 16 of the inner panel 12 includes a plurality of load point areas 20a, 20b, 20c, 20d, 20e, 20f positioned at strategic locations on the outer surface 16. The load point areas 20a, 20b, 20c, 20d, 20e, 20f each made up of a combination of structures that include local reinforcements 22a, 22b, 22c, 22d, 22e, 22f, portions of bulkheads 24a, 24b, 24c that extend across the outer surface 16 and groups of ribs 26a, 26b, 26c, 26d, 26e, 26f; all of which ensure that when external forces are applied to the vehicle panel arrangement 10a the forces are effectively distributed across the load point areas 20a, 20b, 20c, 20d, 20e, 20f of the vehicle panel arrangement 10a. Bulkheads 24a, 24b, 24c are raised surfaces formed on the outer surface 12 that distribute loads applied to the exterior panel 18 to the local point areas 20a, 20b, 20c, 20d, 20e, 20f.

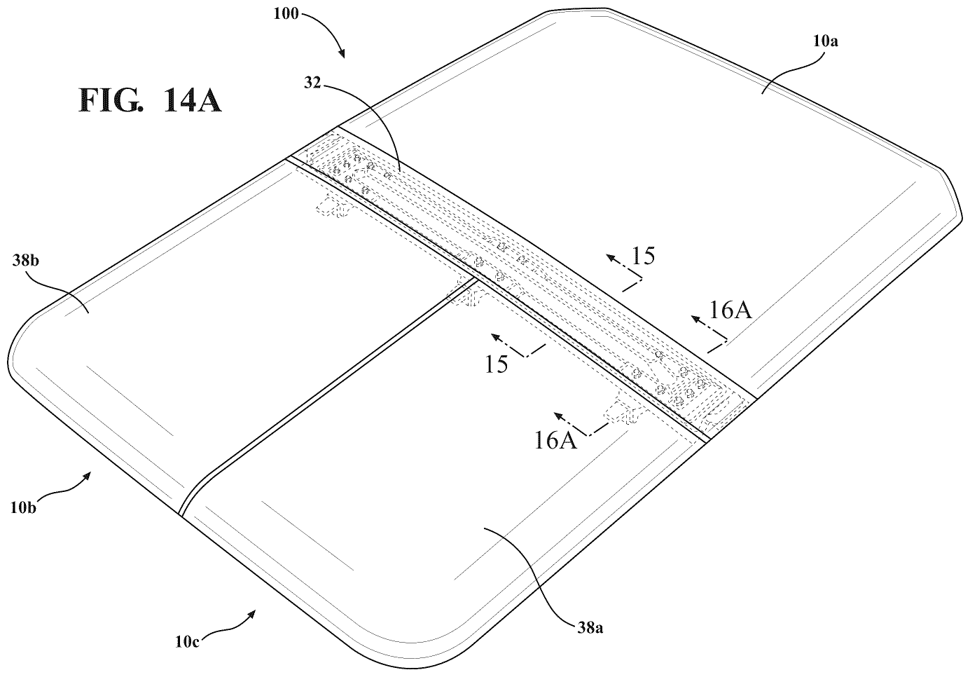

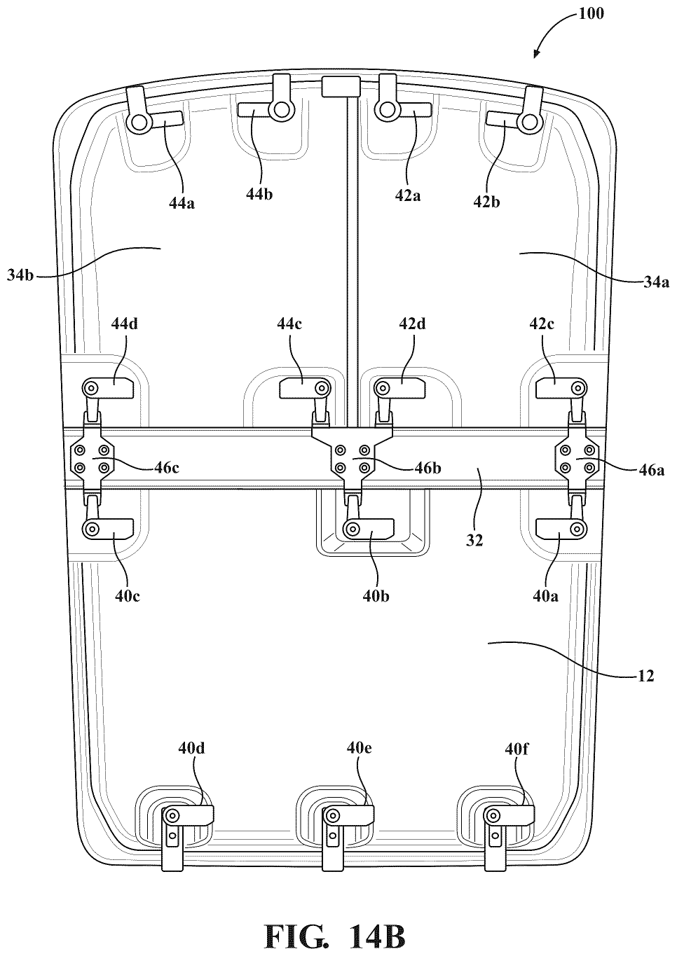

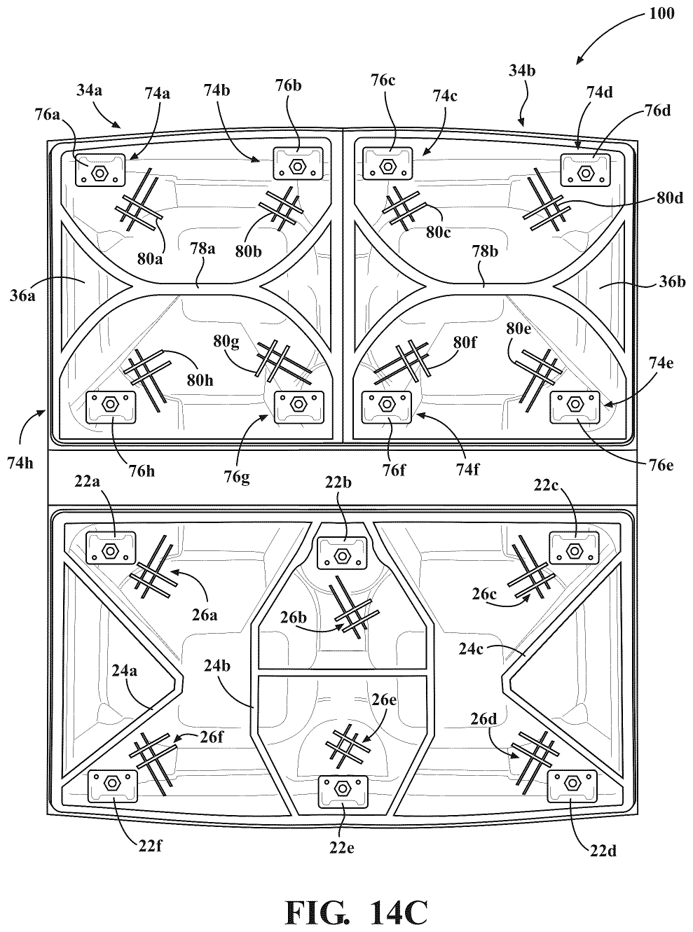

The vehicle panel arrangement 10a shown in FIG. 1 is a roof panel that is a single panel that serves as a roof of a vehicle. However, as shown in FIGS. 14A and 14B the vehicle panel arrangement 10a in another embodiment is a subpart of a roof arrangement 100 of a vehicle that includes the vehicle panel 10a, a continuous reinforcement 32 and two additional vehicle panels 10a, 10c that altogether include four removable pieces. Referring now to FIG. 14C the vehicle panels 10b, 10c have the similar structures as vehicle panel 10a in that they each have inner panel 34a, 34b, with an outer surface 36a, 36b, and an exterior panel 38a, 38b however; the size of the vehicle panels 10b, 10c is smaller than vehicle panel 10c so the inner panel 34a, 34b and exterior panel 38a, 38b are smaller. Vehicle panel 10b, 10c shown in FIGS. 14a-14c each include inner panel 34a, 34b, forming the inside surface of each vehicle panel 10b, 10b, and the outer surface 36a, 36b which is covered by the exterior panel 38a, 38b. The outer surface 36a, 36b each have a plurality of load point areas 74a, 74b, 74c, 74d, 74e, 74f, 74g, 74h positioned at strategic locations on the outer surface 36a, 36b. The load point areas 74a, 74b, 74c, 74d, 74e, 74f, 74g, 74h each made up of a combination of structures that include local reinforcements 76a, 76b, 76c, 76d, 76e, 76f, 76g, 76h, portions of bulkheads 78a, 78b that extend across the outer surface 36a, 36b and groups of ribs 80a, 80b, 80c, 80d, 80e, 80f, 80g, 80h all of which ensure that when external forces are applied to the vehicle panel arrangement 10b, 10c, the forces are effectively distributed across the load point areas 74a, 74b, 74c, 74d, 74e, 74f, 74g, 74h of the vehicle panel arrangement 10b, 10c. Bulkheads 78a, 78b are raised surfaces formed on the outer surface 36a, 36b that distribute loads applied to the exterior panel 38a, 38b to the local point areas 74a, 74b, 74c, 74d, 74e, 74f, 74g, 74h. Also as shown in FIG. 14b the vehicle panels 10a, 10b, 10c each have rotatable handles 40a-f, 42a-d, 44a-d that rotate to lock the respective vehicle panel 10a, 10b, 10c to latch plates discussed in detail below.

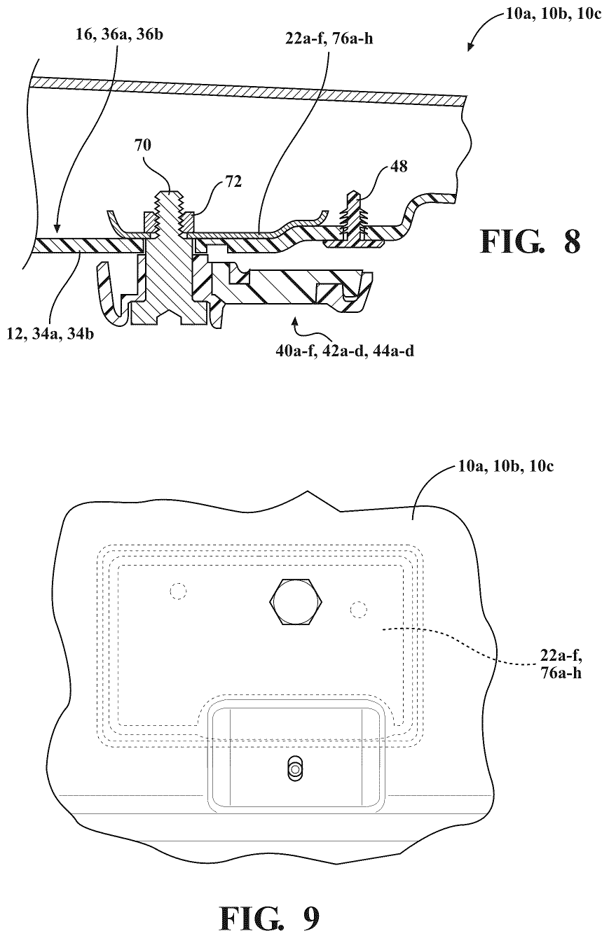

Referring to FIG. 8 a partial side elevational view of a portion of vehicle panel arrangement 10a, 10b, 10c with one of the rotatable handles 40a-f, 42a-d, 44a-d. Also referring to FIG. 9 a partial bottom plan view of the local reinforcement 22a-f, 76a-h with the handle 40a-f, 42a-d, 44 a-d removed. The local reinforcement 22a-f, 76a-h is connected to the respective outer surface 16, 36a, 36b of the inner panel 12, 34a, 34b using adhesives, sonic welding, insert molding, mechanical fasteners or other suitable techniques. The handle 40a-f, 42a-d, 44 a-d has a shaft 70 that rotatably slides though an aperture in the inner panel 12, 34a, 34b and local reinforcement 22a-f, 76a-h and is fastened with a nut 72. The local reinforcement 22a-f, 76a-h provides support to the inner panel 12, 34a, 34b when forces are applied to the handle 40a-f, 42a-d, 44 a-d such as during rotation to release or unlock the vehicle panel arrangement 10a, 10b, 10c.

Each local reinforcement 22a-f, 76a-h, are plates of hard plastic or metal that connected to the outer surface 16, 36a, 36b of the inner panel 12, 34a, 34b using infrared welding, adhesives, fasteners, over-molding or other suitable techniques. In the embodiments of the invention shown in FIGS. 1, 2, 8, 9, 14A, 14B, 14C, 15, 16A, and 16B each local reinforcement 22a-f, 76a-h is used to connect and support forces exerted on the rotatable handle 40a-f, 42a-d, 44 a-d. As shown in FIGS. 1 and 14C each local reinforcement 22a-f, 76a-h covers a respective one of the point load areas 20a-f, 74a-h such that when a force is applied to a respective load point areas 20a-f, 74a-h the forces are distributed through the respective local reinforcement 22a-f, 76a-h to the inner panel 12, 34a, 34b. Examples of the types of loads exerted include rotation of the handle, wind, weight applied to the vehicle panel arrangement 10a, 10b, 10c.

As shown in FIG. 14B rotatable handle 40a, 40b, 40c, 42c, 42d, 44c, 44d each rotate to respectively engage a latch plate 46a, 46b, 46c on the continuous reinforcement 32. This locks the vehicle panel 10a, 10b, 10c to the continuous reinforcement 32. Rotatable handle 40d, 40e, 40f, 42a, 42b, 44a, 44b rotate to engage latch plates (not shown) connected to portions of the vehicle frame to lock the vehicle panel 10a, 10b, 10c to the vehicle. Referring to FIG. 8 there is an alignment button 48 that is a vertically moveable mechanical button that frictionally engages and provides resistance to the rotatable handle 40a-f, 42a-d, 44a-d when it is rotated to the locked position. This provides the user operating the rotatable handle 40a-f, 42a-d, 44a-d with confirmation that the rotatable handle 40a-f, 42a-d, 44a-d has properly aligned with and engaged the latch plate.

Referring now to FIGS. 1 and 14C, the bulkheads 24a, 24b, 24c are integrally molded to and extend from the outer surface 16 of the inner panel 12 to enhance structural integrity and load distribution. The bulkheads 24a, 24b, 24c, 78a, 78b as shown extend between two peripheral edges of the respective one of the inner panels 12, 34a, 34b so as to distribute loads across the inner panel 12, 34a, 34b. Also the bulkheads 24a, 24b, 24c, 78a, 78b have an edge that terminates at and contacts a respective a respective one of the groups of ribs 26 a-f, 80a-h to allow forces and loads to be transferred between the bulkheads and the ribs. Referring now to FIG. 2 a cross-sectional view of vehicle panel arrangement 10a is shown with details of bulkhead 24b. The bulkhead 24b has a leg portion 28 extending from the outer surface 16 of the inner panel 12 to a shelf portion 30 at a distal end that is in contact with and bonded to the inside surface 14 of the exterior panel 18. While only bulkhead 24b is shown the analogous leg and shelf features are found on bulkheads 24a, 24c, 78a, 78c. The inside surface 14 of the exterior panel 18 covers the plurality of local reinforcements 22a, 22b, 22c, 22d, 22e, 22f, groups of ribs 26a, 26b, 26c, 26d, 26e, 26f and the bulkheads 24a, 24b, 24c to form the vehicle closure panel arrangement 10. The bonding between the shelf portion 30 and the inside surface 14 is accomplished using infrared welding, adhesives, resistive implant welding or other suitable connection methods.

Referring now to FIGS. 14A, 14B and 14C the details of the continuous reinforcement 32 will now be described. The continuous reinforcement 32 adds strength to the roof arrangement 100 of the vehicle because it is in contact with the inner panel 12, 34a, 34b and in contact with at least two locations on a vehicle body structure. When loads or forces are applied to roof arrangement, they are transferred across the continuous reinforcement 32 to the vehicle body structure. The continuous reinforcement 32 allows for the three vehicle panel arrangements 10a, 10b, 10c to be connected to be removably connected to a vehicle creating the roof arrangement 100 that covers a large roof area, and to allows each individual vehicle panel arrangement 10a, 10b, 10c to carry a significant weight load by enhancing load distribution and structural strength.

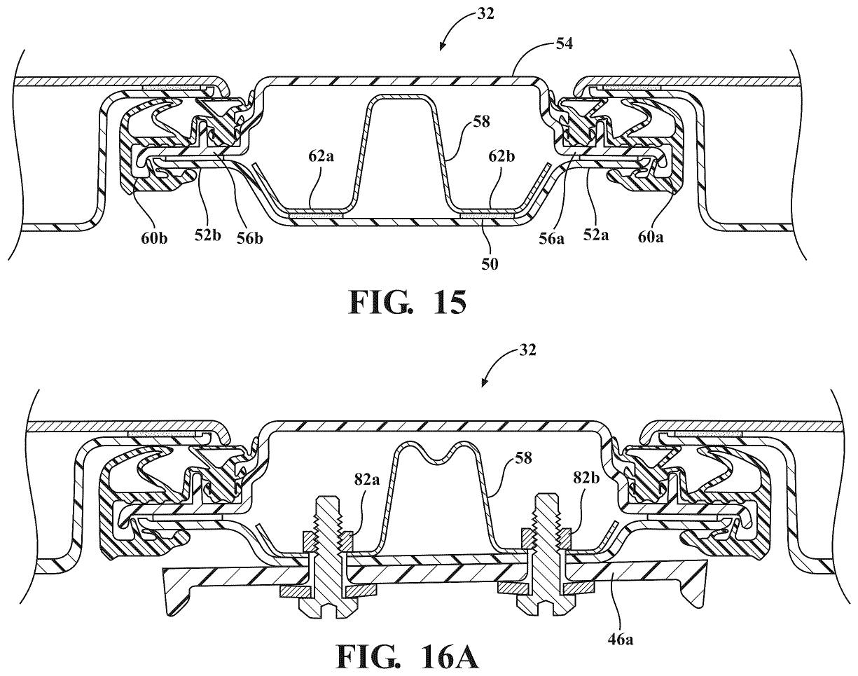

FIG. 15 shows the details of the structure of the continuous reinforcement 32. In particular the continuous reinforcement 32 has an interior portion 50 with flanges 52a, 52b. The continuous reinforcement 32 has an exterior portion 54 with flanges 56a, 56b and an elongated reinforcement plate 58 connected to the interior portion 50 between the interior portion 50 and the exterior portion 54. The elongated reinforcement plate 58 functions to provide strength to the continuous reinforcement. The flanges 52a, 52b of the interior portion 50 are connected to the flanges 56a, 56b of the exterior portion 54. The continuous reinforcement 32 further includes seals 60a, 60b positioned between the exterior portion 54 of the continuous reinforcement 32 and the inner surface 14, 36a, 36b of the vehicle panel arrangement 10a, 10b, 10c. The elongate reinforcement plate 58 has a cross-section that is a W shape with two lower humps 62a, 62b that contact the interior portion 50 of the continuous reinforcement 32. The elongated reinforcement plate 58 is formed of metal or fiber filled polymer to provide the necessary strength. The ends of the elongated reinforcement plate 58 are connected to the vehicle body.

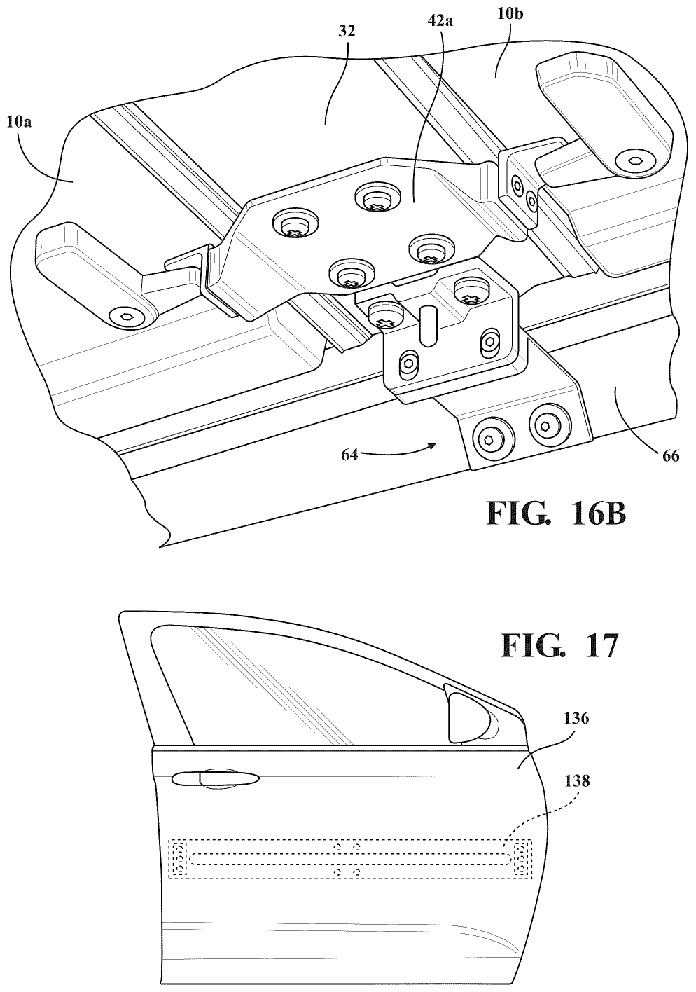

FIG. 16A shows a second cross sectional view of the continuous reinforcement 32. As shown the latch plate 46a connects directly to the elongated reinforcement plate 58 using fasteners that extend though apertures in the respective two lower humps 62a, 62b and are held in place with a nut 82a, 82b. While fasteners are depicted it is within the scope of the invention the connection to also be accomplished using adhesives and welding. The other latch plates 46a, 46c, 46d are also connected in a similar manner. Forces applied to the latch plates 46a-d are transferred through the elongated plate 58 to the vehicle body.

FIG. 16B shows a bottom perspective view of the latch plate 46a and the connection of the vehicle panels 10a, 10b to the continuous reinforcement 32 using the rotatable handles. The continuous reinforcement 32 has a mount bracket 64 that is used to connect it to a frame 66 of the vehicle. The mount bracket 64 is connected to the elongated reinforcement plate 58 similar to the connection of latch plate 46a to the reinforcement plate 58 shown in FIG. 16A.

FIG. 19 is an enlarged perspective view of one of the groups of ribs 26 a-f, 80a-f all of which have similar structures. Each group of ribs 26 a-f, 80a-f have parallel walls 68a, 68b,68c, 68d that are integrally molded and extend away from the outer surface 16, 36a, 36b of the inner panel 12, 34a, 34b. Parallel walls 68a, 68b bisect parallel walls 68c, 68d which allows the distribution of forces between the parallel walls 68a, 68b, 68c, 68d. Each of the groups of ribs 26 a-f, 80a-f are in contact with a respective one of the point load areas 20 a-f, 74a-f and provide support to the handles 40 a-f. Also, each of the bulkheads 24 a-c, 78a, 78b is in contact with one or more of the groups of ribs 26 a-f, 80a-f to facilitate the transfer of forces between the bulkheads 24 a-c, 78a, 78b and the groups of ribs 26 a-f, 80a-f.

The vehicle panel arrangements 10 a-c all depict the horizontal vehicle panels that are roof panels (i.e., FIG. 1) or are all connected together to form the roof arrangement 100 (i.e., FIGS. 14A, 14B, 14C). However, it is within the scope of the invention for the vehicle panel arrangements to be horizontal or vertical vehicle panels used in other applications. FIGS. 3-7, 10-13, 17, 18 and 20-23 depicts other applications of vehicle panels and show the location and use of bulkheads, local reinforcements, continuous reinforcements and groups of ribs, all of which are used individually in the vehicle pane or in combination with each other, similar to the vehicle panel 10a shown in FIG. 1.

FIG. 3 provides a front perspective view of a vehicle 84 with a vehicle panel arrangement that is a frunk closure 86 formed from two composite panels similar to inner panel 12, 34a, 34b and exterior panel 18, 38a, 38b described above. This frunk closure 86 of this embodiment of the invention features bulkheads 88 to reinforce frunk closure 86. The figure demonstrates how these bulkheads 88 are integrated into the frunk closure 86, contributing to load distribution and overall durability.

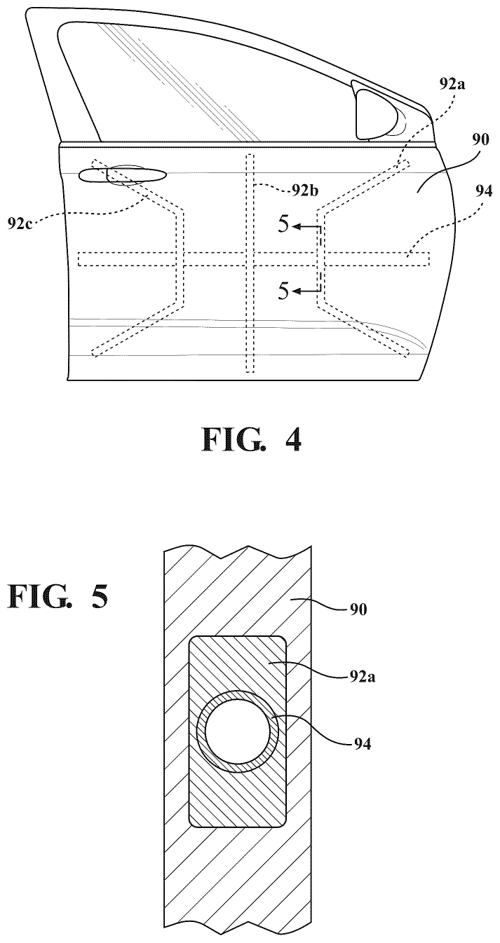

FIG. 4 showcases a side perspective elevational view of a vehicle panel arrangement, specifically a side door 90 formed from two composite panels similar to inner panel 12, 34a, 34b and exterior panel 18, 38a, 38b described above. This side door 90 is equipped with bulkheads 92a, 92b, 92c and a continuous reinforcement 94. FIG. 4 highlights how these bulkheads 92a, 92b, 92c are incorporated into and reinforce the side door 90, bolstering its strength and resilience. FIG. 5 is an enlarged cross-sectional side view focusing on a portion of the side door 90, bulkhead 92a and continuous reinforcement 94. This detailed view exemplifies how the bulkhead 92a surrounds and supports the continuous reinforcement 94 to reinforce the side door's structure and distribute loads effectively in a vehicle side door. As shown the continuous reinforcement 94 extends across a length of the side door 90. At the ends of the continuous 94 reinforcement there are bulkheads that circumscribe the continuous reinforcement 94 so that forces at any point along the continuous reinforcement are distributed along the length of the continuous reinforcement 94 and then distributed through the bulkheads 92a, 92b, 92c. Any forces applied to the side door 90 in an area of one of the bulkheads 92a, 92b, 92c, will be transferred through the continuous reinforcement 94 to the other one of the bulkheads 92a, 92b, 92c to effectively spread the forces across the side door 90.

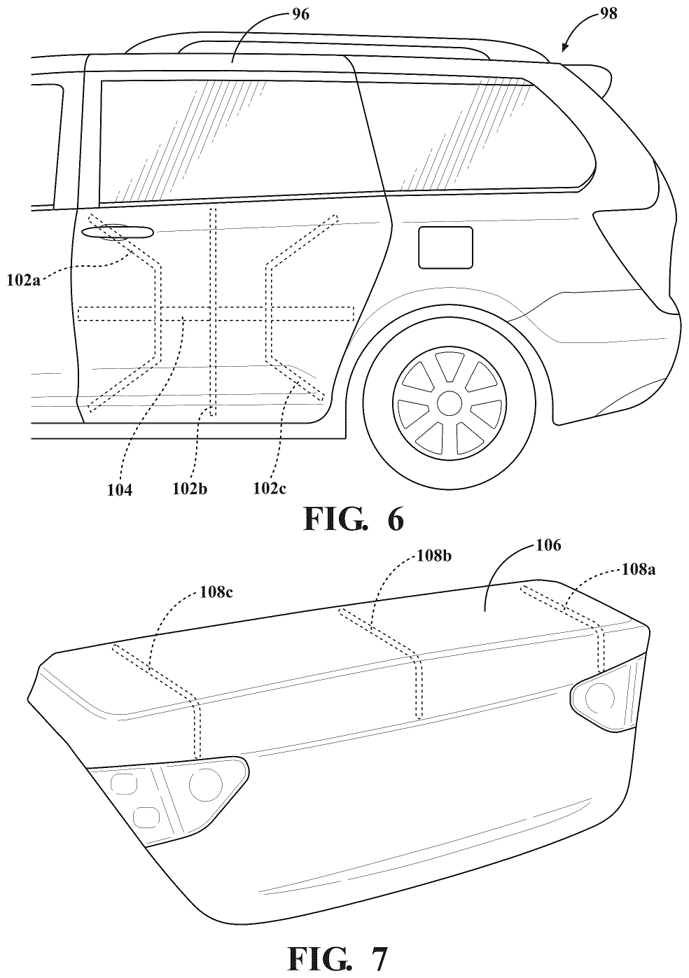

FIG. 6 is a side perspective elevational view of a vehicle panel arrangement that is a sliding side door 96 on a vehicle 98. The sliding door 96 is formed from two composite panels similar to inner panel 12, 34a, 34b and exterior panel 18, 38a, 38b described above. This particular application includes bulkheads 102a, 102b, 102c totaling three in number and a continuous reinforcement 104 extending between the bulkheads 102a, 102b, 102c. This particular application has three bulkheads 102a, 102b, 102c and one continuous reinforcement 104, however a greater or lesser number of bulkheads and reinforcements are needed depending on the needs of a particular application. FIG. 6 illustrates how the bulkheads contribute to the strength and durability of the sliding side door.

FIG. 7 is a top perspective view of a vehicle panel arrangement, specifically a trunk closure 106 formed from two composite panels similar to inner panel 12, 34a, 34b and exterior panel 18, 38a, 38b described above. The trunk closure 106 features bulkheads 108a, 108b, 108c to enhance structural integrity and load distribution. The figure illustrates how these bulkheads 108a, 108b, 108c are applied to a practical vehicle component, such as the trunk closure 106.

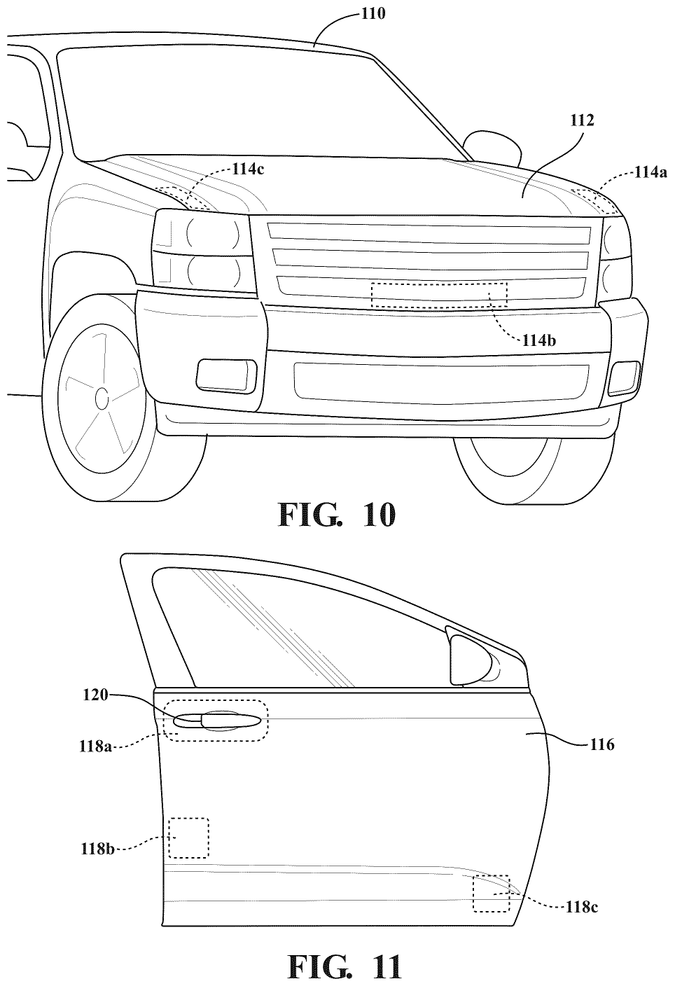

FIG. 10 shows a front perspective view of a vehicle 110 with a frunk closure 112 is shown. The frunk closure 112 is formed from two composite panels similar to inner panel 12, 34a, 34b and exterior panel 18, 38a, 38b described above. Frunk closure 112 is an example of another application featuring local reinforcements 114a, 114b, 114c that are similar to local reinforcements 22a-f, 76a-h shown in FIG. 14C. While the present application shows three local reinforcements 114a, 114b, 114c it is within the scope of the invention for a greater or lesser number of local reinforcements to be used depending on the needs of a particular application.

FIG. 11 shows a side perspective elevational view of a vehicle panel, specifically a side door 116 formed from two composite panels similar to inner panel 12, 34a, 34b and exterior panel 18, 38a, 38b described above. The side door 116 is equipped with local reinforcements 118a, 118b, 118c. Each local reinforcements 118a, 118b, 118c is used to provide an area of strength for features of the side door 116. Reinforcement 118a is used to provide support to an area for attachment of a handle 120. Reinforcement 118b is used to support an area used to connect a latch mechanism, while reinforcement 118c is used for supporting the mounting of a light housing. While three local reinforcements 118a, 118b, 118c are shown, it is within the scope of this invention for a greater or lesser number to be used depending on a particular application. This side door 116 is an example of another application featuring local reinforcements 118a, 118b, 118c that are similar to local reinforcements 22a-f, 76a-h shown in FIG. 14C.

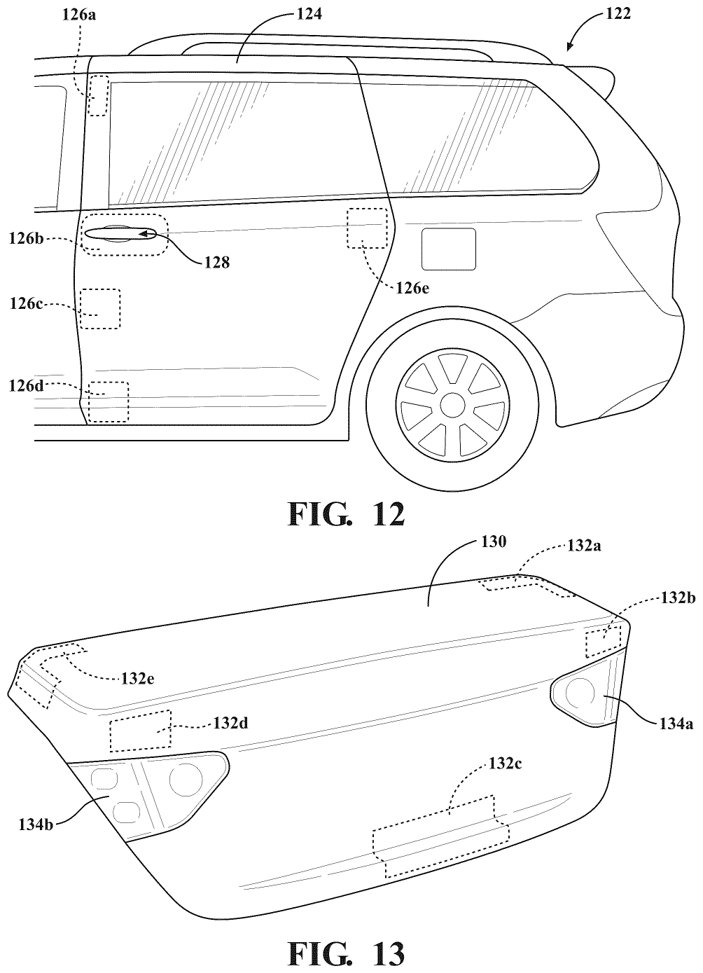

FIG. 12 provides a side perspective elevational view of a vehicle 122 featuring a sliding side door 124 that is formed from two composite panels similar to inner panel 12, 34a, 34b and exterior panel 18, 38a, 38b described above. This sliding side door 124 is equipped with local reinforcements 126a, 126b, 126c, 126d, 126e that provide local support at specific areas of the sliding door 124. Local reinforcements 126a, 126d are used to support attachment of door latch mechanisms. Local reinforcement 126c is used to attach a window regulator and local reinforcement 126b is used to support and connect a handle 128 to the sliding door 124. Local reinforcement 126e is used to support connection of a portion of a door actuator mechanism used to slide the sliding door 124 between an open and closed position. This sliding door 124 is an example of another application featuring local reinforcements 126a, 126b, 126c, 126d, 126e that are similar to local reinforcements 22a-f, 76a-h shown in FIG. 14C.

FIG. 13 shows a top perspective view of a vehicle panel arrangement, specifically a trunk closure 130. The trunk closure 130 is formed from two composite panels similar to inner panel 12, 34a, 34b and exterior panel 18, 38a, 38b described above. The trunk closure 130 features local reinforcements 132a, 132b, 132c, 132d, 132e to provide local support at specific areas of the trunk closure 130. Local reinforcements 132a, 132e are used to provide reinforcement for hinges, local reinforcements 132b and 132d are used to provide support for connection of lights 134a, 134b and local reinforcement 132c is used to support a latch mechanism for the trunk closure 130. This trunk closure 130 is an example of another application featuring local reinforcements 132a, 132b, 132c, 132d, 132e similar to local reinforcements 22a-f, 76a-h shown in FIG. 14C.

FIG. 17 showcases a side perspective elevational view of a vehicle panel, specifically a side door 136 formed from two composite panels similar to inner panel 12, 34a, 34b and exterior panel 18, 38a, 38b described above. The side door 136 further includes a continuous reinforcement 138 having a similar cross-sectional structure as the continuous reinforcement 32 shown and described above. The continuous reinforcement 138 enhances the strength and load-bearing capabilities of the side door 136.

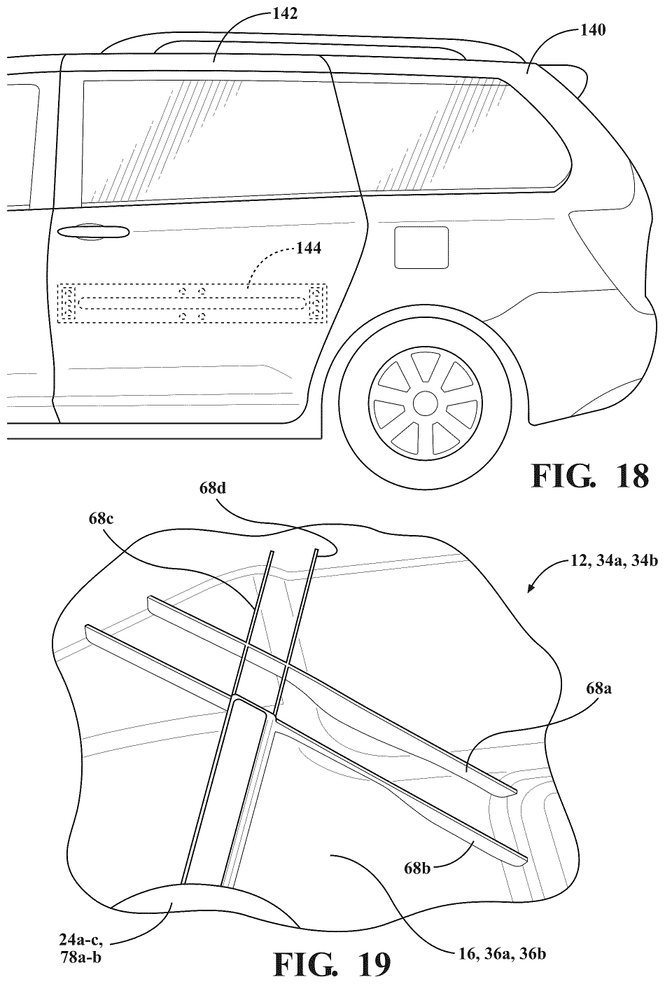

In FIG. 18, a side perspective elevational view of a vehicle 140 with a sliding side door 142 is presented. The sliding door 142 is formed from two composite panels similar to inner panel 12, 34a, 34b and exterior panel 18, 38a, 38b described above. This sliding side door 142 is equipped with continuous reinforcement 144 having a similar cross-sectional structure as the continuous reinforcement 32 shown and described above. The continuous reinforcement 138 enhances the strength and load-bearing capabilities of the side door 136.

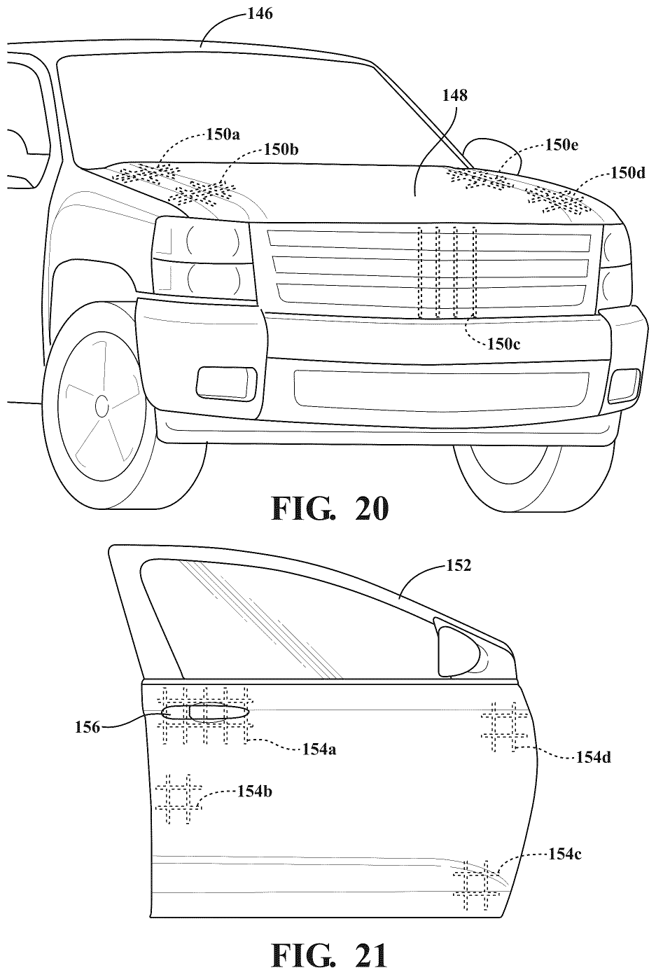

FIG. 20 shows a front perspective view of a vehicle 146 equipped with a frunk closure 148. The frunk closure 148 is formed from two composite panels similar to inner panel 12, 34a, 34b and exterior panel 18, 38a, 38b described above. Frunk closure includes groups of ribs 150a, 150b, 150c, 150d, 150e similar to ribs 26a-f and 80a-h described above. Ribs 150a, 150e are at a location that provides strength and load bearing capabilities to the hinges of the frunk closure 148. Ribs 150b, 150d provide strength and load bearing capabilities at opposing edges and near a location where the frunk closure 148 has a curved surface, while rib 150c provides strength and load bearing capabilities at a front side or what has been referred to as a grille area of the frunk closure 148.

FIG. 21 presents a side perspective elevational view of a vehicle panel, specifically a side door 152. The side door 152 is formed from two composite panels similar to inner panel 12, 34a, 34b and exterior panel 18, 38a, 38b described above. This side door 152 is equipped with groups of ribs 154a, 154b, 154c, 154d similar to ribs 26a-f and 80a-h described above. Ribs 154d and 154c are at a location that provides strength and load bearing capabilities to the hinges of the side door 152. Ribs 154a and 154b provide strength and load bearing capabilities an edge of the side door 152, and rib 154a is at a location that provides support where a handle 156 is mounted.

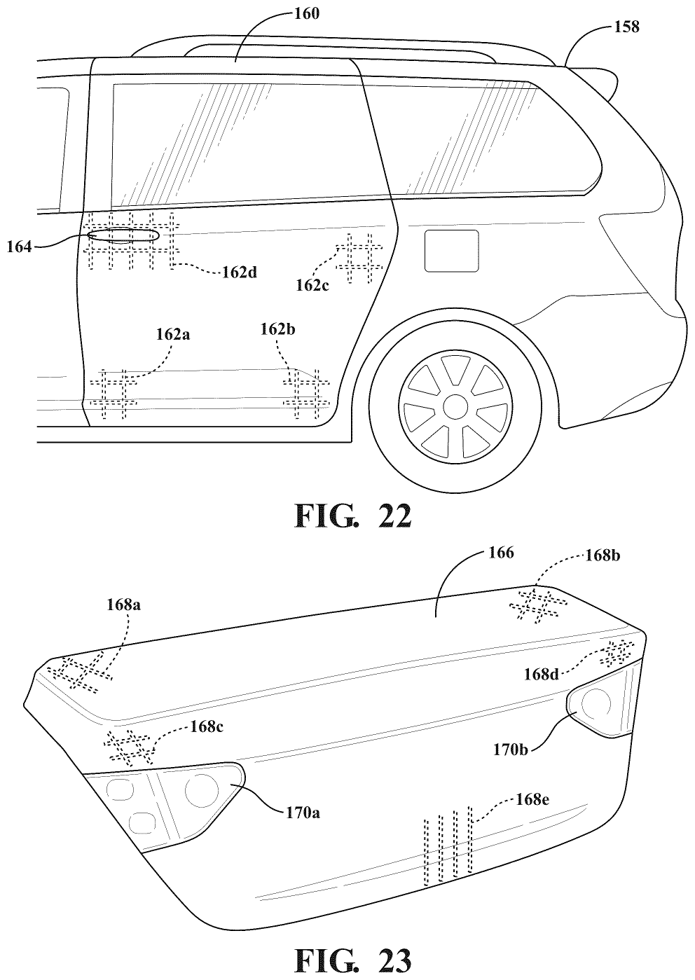

In FIG. 22, a side perspective elevational view of a vehicle 158 with a sliding door 160 that is formed from two composite panels similar to inner panel 12, 34a, 34b and exterior panel 18, 38a, 38b described above. This sliding side door 124 is formed using ribs 162a, 162b, 162c, 162d that provide local support and load distribution on the sliding door 160. Ribs 162a, 162b 162d support edges of the sliding door 160. Ribs 162d further support a handle 164 that is connected to the sliding door 160. Ribs 162a, 162b further support connection points for bottom sliding mechanisms such as rollers. Ribs 162c support and edge of the sliding door 160 and also connection of a portion of a door actuator mechanism used to slide the sliding door 160 between an open and closed position.

FIG. 23 is a top perspective view of a vehicle panel arrangement, specifically a trunk closure 166 that is formed from two composite panels similar to inner panel 12, 34a, 34b and exterior panel 18, 38a, 38b described above. The trunk closure 166 includes ribs 168a, 168b, 168c, 168d, 168e similar to ribs 26a-f and 80a-h described above. Ribs 168a, 168b are at locations that provide strength at the edges and load bearing capabilities for connection of hinges to the trunk closure 162. Ribs 168c and 168d provide strength and load bearing capabilities to an edge of the trunk closure 166 and for connection of rear taillights 170a, 170b. Ribs 168e provide strength and support to at a location where the locking latch for the trunk closure 166 is connected.

It is to be understood that the specific embodiments described above are merely illustrative of the principles of the invention. Various modifications may be made by those skilled in the art without departing from the scope of the invention as claimed.

What is claimed is:

1. A vehicle panel arrangement comprising:
an inner panel having an outer surface and an inner surface forming a portion of a vehicle closure panel;
a plurality of load point areas formed on the outer surface of the inner panel;
a plurality of local reinforcements connected to the outer surface of the inner panel, each one of the plurality of local reinforcements covers a respective one of the plurality of load point areas such that when a force is applied to said plurality of load point areas, the force is distributed through the plurality of local reinforcements to the inner panel;
a continuous reinforcement in contact with the inner panel and in contact with at least two locations on a vehicle body structure, wherein loads applied to said inner panel or to the continuous reinforcement are transferred across the continuous reinforcement to the vehicle body structure;
an exterior panel with an inside surface connected to the inner panel and at least partially covering the plurality of local reinforcements, and
a plurality of molded bulkheads formed on and extending from the outer surface of the inner panel, where in each of the plurality of molded bulkheads has a shelf portion at a distal end that is in contact with and bonded to the inside surface of the exterior panel.

2. The vehicle panel arrangement of claim 1, further comprising:
a plurality of rotatable latches connected to the inner surface of the inner panel, wherein each of the plurality of rotatable latches has a connection that extends through the inner panel and rotatably connects to a respective one of the plurality of load point areas and to one of the plurality of local reinforcements.

3. The vehicle panel arrangement of claim 2, further comprising a latch plate connected to the continuous reinforcement so that one or more of the plurality of rotatable latches engages the latch plate when in a locked position.

4. The vehicle panel arrangement of claim 1 where in at least one of the plurality of molded bulkheads extends between two peripheral edges of the inner panel.

5. The vehicle panel arrangement of claim 1, further comprising a plurality of ribs formed on and extending from the outer surface of the inner panel, wherein one or more of the plurality of ribs are in contact with a respective one of the plurality of load point areas.

6. The vehicle panel arrangement of claim 5, wherein at least one of the plurality of molded bulkheads has an edge that contacts one of the plurality of groups of ribs.

7. The vehicle panel arrangement of claim 1 wherein each shelf of the plurality of molded bulkheads is connected to the exterior panel by an infrared welding.

8. The vehicle panel arrangement of claim 1, wherein the vehicle panel arrangement is a horizontal or vertical panel for a vehicle.

9. The vehicle panel arrangement of claim 1, wherein the vehicle panel arrangement is one selected from a group consisting of a frunk, a sliding side door, a trunk closure, a hood, a side door and a portion of a vehicle roof.

10. The vehicle panel arrangement of claim 1 wherein the continuous reinforcement includes an interior portion with a flange, and exterior portion with a flange and an elongated reinforcement plate connected to the interior portion between the interior portion and the exterior portion, wherein the flange of the interior portion is connected to the flange of the exterior portion.

11. The vehicle panel arrangement of claim 10 wherein the contact between the continuous reinforcement and the inner panel further includes one or more seals positioned between the exterior portion of the continuous reinforcement and the inner surface of the inner panel.

12. The vehicle panel arrangement of claim 10 wherein the elongated reinforcement plate has a cross-section that is a W shape with two lower humps that contact the interior portion of the elongated reinforcement plate.

13. A vehicle panel arrangement comprising:
an inner panel having an outer surface and an inner surface forming a portion of a vehicle closure panel, and
an exterior panel with an inside surface connected to the inner panel;
wherein the inner panel includes at least one of a group comprising a plurality of load point areas formed on the outer surface of the inner panel, a plurality of local reinforcements connected to the outer surface of the inner panel, each one of the plurality of local reinforcements covers a respective one of the plurality of load point areas such that when a force is applied to said plurality of load point areas the force is distributed through the plurality of local reinforcements to the inner panel, a continuous reinforcement in contact with the inner panel and the exterior panel, a plurality of molded bulkheads formed on and extending from the outer surface of the inner panel, where in each of the plurality of molded bulkheads has a shelf portion at a distal end that is in contact with and bonded to the inside surface of the exterior panel, and a plurality of ribs formed on the inner panel.

14. The vehicle panel arrangement of claim 13, wherein the vehicle panel arrangement is a horizontal or vertical panel for a vehicle.

15. The vehicle panel arrangement of claim 13, wherein the vehicle panel arrangement is one selected from a group consisting of a frunk, a sliding side door, a trunk closure, a hood, a side door and a portion of a vehicle roof.

16. A vehicle panel arrangement comprising:
an inner panel having an outer surface and an inner surface forming a portion of a vehicle closure panel;
a plurality of molded bulkheads formed on and extending from the outer surface of the inner panel, where in each of the plurality of molded bulkheads has a shelf portion at a distal end that is in contact with and bonded to an inside surface of an exterior panel, and
an exterior panel with an inside surface connected to the inner panel and at least partially covering a plurality of local reinforcements.

17. The vehicle panel arrangement of claim 16 further comprising a continuous reinforcement in contact with the inner panel and the exterior panel, wherein loads applied to the inner panel or the exterior panel are transferred across the continuous reinforcement.

18. The vehicle panel arrangement of claim 17, wherein the continuous reinforcement includes an interior portion with a flange, and exterior portion with a flange and an elongated reinforcement plate connected to the interior portion between the interior portion and the exterior portion, wherein the flange of the interior portion is connected to the flange of the exterior portion.

19. The vehicle panel arrangement of claim 18 wherein the elongated reinforcement plate has a cross-section that is a W shape with two lower humps that contact the interior portion of the elongated reinforcement plate.

20. The vehicle panel arrangement of claim 16, wherein the vehicle panel arrangement is one selected from a group consisting of a frunk, a sliding door, a trunk closure, a hood, a side door and a portion of a vehicle roof.
